(19) United States
(12) Patent Application Publication
(10) Pub. No.: US 2019/0213088 A1
(43) Pub. Date: Jul. 11, 2019

(54) SYSTEM AND METHOD FOR GENERATING A SYNTHETIC BACKUP IN A REDUNDANT STORAGE SOLUTION

(71) Applicant: SOFTNAS OPERATING INC., Houston, TX (US)

(72) Inventors: Eric OLSON, Melbourne, FL (US); Kash PANDE, Kincardine (CA); Albert LEE, Manhattan, KS (US)

(73) Assignee: SOFTNAS OPERATING INC., Houston, TX (US)

(21) Appl. No.: 16/242,614

(22) Filed: Jan. 8, 2019

Related U.S. Application Data
(60) Provisional application No. 62/614,938, filed on Jan. 8, 2018.

(51) Int. Cl. G06F 11/14; G06F 12/12; G06F 12/0866; G06F 16/182

(52) U.S. Cl. CPC G06F 11/1464; G06F 11/1469; G06F 11/1451; G06F 2201/835; G06F 12/12; G06F 12/0866; G06F 16/182; G06F 11/1471

(57) ABSTRACT

A method for generating a synthetic backup comprises generating a full backup of a data source at an initial timestamp and generating a first incremental backup of the data source at a first timestamp subsequent to the initial timestamp. The first incremental backup comprises one or more modifications made to data stored in the data source between the initial timestamp and the first timestamp. A synthetic backup is generated from at least the full backup and the first incremental backup by altering one or more file system parameters of the data source and performing forwards reads for the first incremental backup based on the modified file system parameters. In response to determining that forward read data has not been merged into a synthetic backup, the forward read data is stored in a read cache and the full backup is merged with the forward read data in the read cache.

### CROSS-REFERENCE TO RELATED APPLICATIONS

This application claims the benefit of U.S. Provisional Application Ser. No. 62/614,938 filed Jan. 8, 2018 and entitled “SYSTEM AND METHOD FOR GENERATING A SYNTHETIC BACKUP IN A REDUNDANT STORAGE SOLUTION”, which is hereby incorporated by reference in its entirety.

### TECHNICAL FIELD

The present disclosure generally pertains to data storage and backup, and more specifically pertains to systems and methods for synthetic backups in cloud network environments.

### BACKGROUND

Synthetic backup operations include the creation of a full or master backup at a first point and time and the subsequent concatenation of incremental backups to the master backup at pre-determined periods in time. When operating in the cloud, synthetic backup operations are input/output (I/O) intensive and can interfere with general operations (e.g., read/writes) in the cloud. It would be desirable to provide systems and methods for performing synthetic backup operations without interfering with general operations in the cloud.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram illustrating an example system for generating a synthetic backup in a redundant storage solution;

FIG. 2 is a flow diagram illustrating an example method for generating a synthetic backup to a cloud storage system; and

FIG. 3 depicts an example computing system in which various embodiments of the present disclosure can be implemented or provided.

### DETAILED DESCRIPTION

Reference will now be made in detail to aspects and embodiments of the present disclosure, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems and methods for generating a synthetic backup in an object storage system (e.g., Azure Blobs, AWS S3, etc.), whereby the object storage system can generate a complete backup by concatenating incremental backups with a master backup. In some embodiments, one or more of the full backups and/or incremental backups discussed herein can be, for example, Veeam backups. In some embodiments, the object storage system can be a redundant storage system.

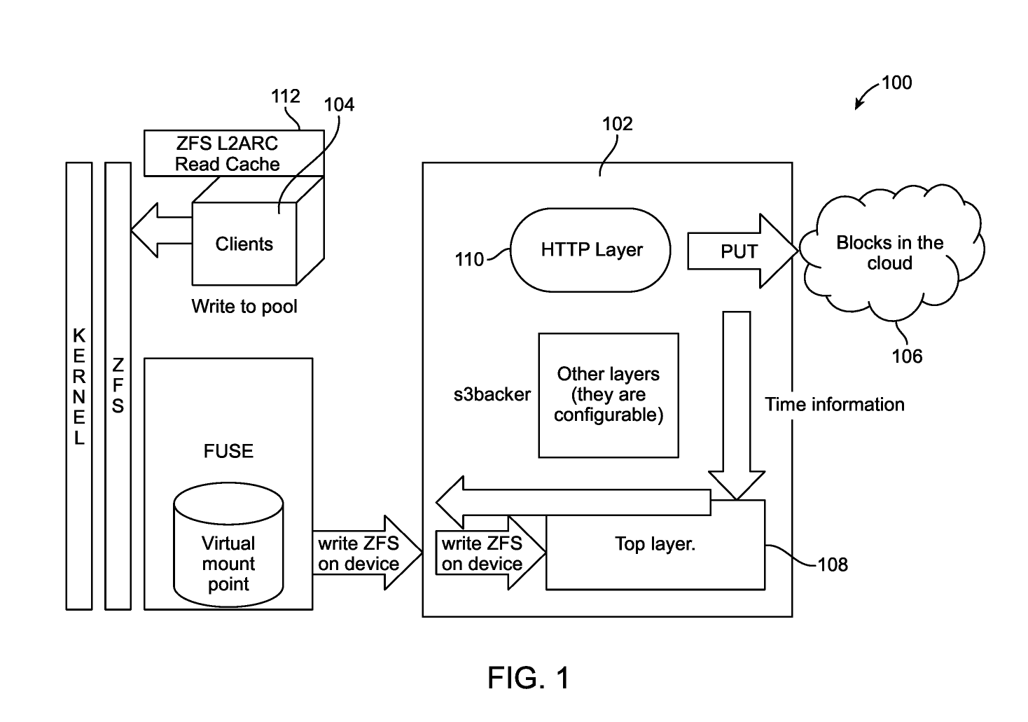

FIG. 1 is a block diagram illustrating an example system 100 for generating a synthetic backup in a cloud storage system. As illustrated, device 102 uploads one or more objects or blocks of data (e.g. from a virtual device) to an object storage system 106. In some embodiments, object storage system 106 can be provided as a cloud storage system (as illustrated in FIG. 1). Examples of such cloud storage systems include Amazon S3, Azure Blobs, and various other cloud object storage systems as would be appreciated by one of ordinary skill in the art. In some embodiments, device 102 can be a virtual loopback device (e.g. s3backer) on top of a filesystem (e.g., S3 filesystem). Device 102 can include several software layers, and each software layer can have a task (e.g., caching, checking that data is not corrupt, etc.).

For example, a top layer 108 can act as a data filter and a lower layer 110 can compute a delay value that enables efficient or optimal operation of device 102. In some embodiments, top layer 108 can receive the calculated delay value from lower layer 110 and provide enforcement of a corresponding delay policy to the incoming data that is filtered by top layer 108. As seen in FIG. 1, lower layer 110 (represented here as an HTTP layer) can compute a delay value and then transmit this delay value to top layer 108 as time information. For example, lower layer 110 can compute this delay value by collecting statistics about the speed or rate at which data is received by or written to the object storage system (e.g., cloud) 106. By feeding back this measured or calculated speed to the top layer 108, lower layer 110 enables top layer 108 to adjust the speed at which device 102 transmits data to the object storage system 106 such that this speed matches or approximates the rate at which data enters device 102 (e.g. as represented by the arrows ‘write ZFS on device’).

Although a ZFS file system is shown in FIG. 1, it is appreciated that other file systems such as EFS can be employed without departing from the scope of the present disclosure. Additionally, although the read cache 112 is depicted in FIG. 1 as an L2ARC (Level 2 Adjustable Replacement Cache)/ZFS cache, the read cache 112 can also be provided as an EFS read cache without departing from the scope of the present disclosure.

In some embodiments, top layer 108 can utilize delay information in a cumulative fashion, e.g. top layer 108 can recognize how many bytes are sent by each of the clients 104 and create a time delay for each client. In response to additional bytes being transmitted from a given one of the clients 104, a corresponding delay value can be incremented or otherwise allowed to accumulate until a certain threshold is reached or exceeded. For example, a threshold delay value could be 25 milliseconds, although it is appreciated that various other threshold values and/or logic can be utilized without departing from the scope of the present disclosure, and moreover, that such threshold values and logic can be pre-configured in the system 100 or can be configured on demand, e.g., by an administrator or user of device 102.

In some embodiments, system 100 may also include an L2ARC/ZFS cache 112 that is configured to store data that will be served locally (e.g., when requested by one or more of the clients 104). Cache 112 can be configured to cache as much of data in a random access memory (RAM) as possible, thereby enabling frequently accessed data to be served to or otherwise accessed by clients 104 very quickly, i.e. much faster than having to go to cloud storage 106 itself.

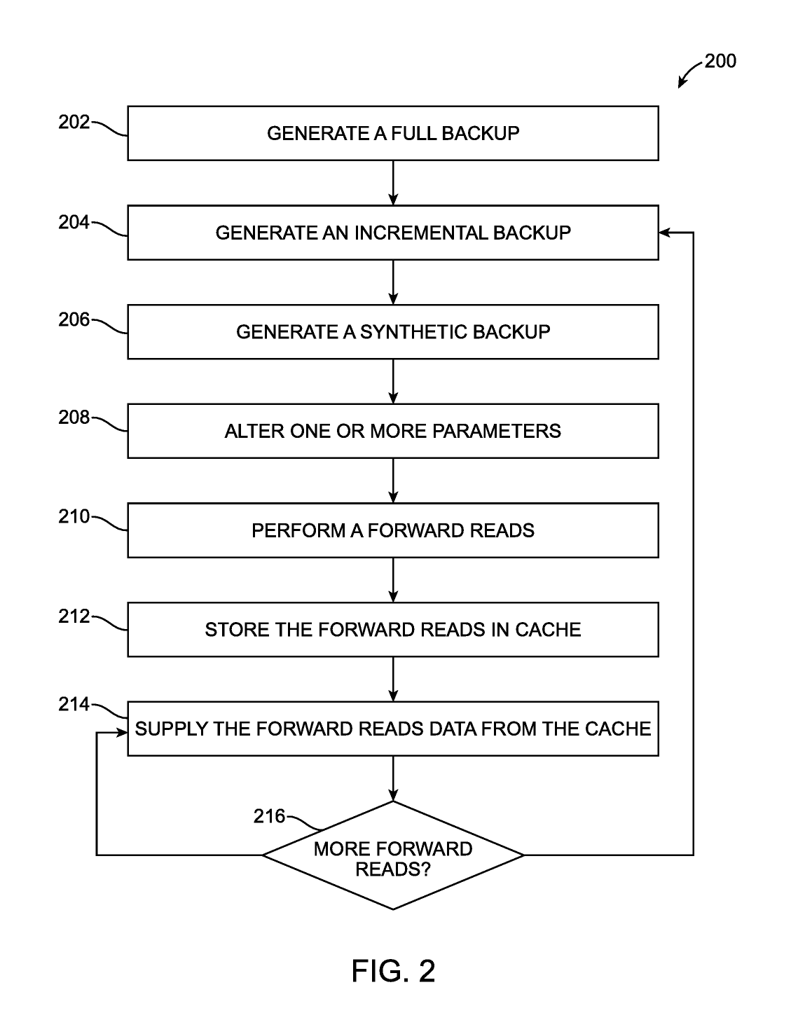

FIG. 2 depicts a flow diagram of an example method 200 for creating a synthetic backup. While the example provided by method 200 is shown as utilizing particular order of blocks, those of ordinary skill in the art will appreciate the method of FIG. 2 and the blocks illustrated therein can be executed in any order that accomplishes the technical advantages of the present disclosure and can include fewer or more blocks than illustrated. Each block shown in FIG. 2 can represent one or more processes, methods, or subroutines, carried out in example method 200. In some embodiments, the blocks illustrated in FIG. 2 can be implemented in the system 100 illustrated in FIG. 1. Accordingly, the description below is made with reference to system 100 for purposes of clarity of explanation and example.

Method 200 can begin at block 202, where a full backup is generated. In some embodiments, the full backup can be a Veeam backup. The full backup can include all data stored in one or more file systems, volumes, storage pools, etc. For example, a full backup can include all data written to the cloud object storage device 106 at a first point in time. For purposes of illustration, consider this full backup to be generated at a time t₁.

At block 204, an incremental backup can be generated to include any or all data written to the one or more file systems, volumes, storage pools, etc., since the full backup (or some previous incremental backup) was generated. This incremental backup is generated at a time t₂. For example, an incremental backup can include all data written to the storage device between time t₁, when the full backup was generated at block 202, and a time t₂, when the generation of the incremental backup was triggered.

At block 206, a synthetic backup can be generated by merging the full backup generated at time t₁ and the incremental backup generated at time t₂. This synthetic backup can be generated such that it is identical or substantially identical to a full backup generated at time t₂. In some embodiments, a synthetic backup can be generated by merging a full backup and one or more incremental backups, or by merging multiple full backups. In some embodiments, the synthetic backup can be a Veeam Synthetic Full Backup. Depending on the composition of the one or more full backups and one or more synthetic backups that are merged in order to create the synthetic backup, the generation of the synthetic backup can be intensive in terms of requisite read and write operations and can thereby negatively affect the operation of cloud object storage system 106. However, this effect can be mitigated in some embodiments by blocks 208-216, which prevent interference with the operation of the storage system (e.g., read/write operations, etc.) when generating synthetic backups.

At block 208, one or more parameters of ZFS prefetch and L2ARC can be altered. For example, the one or more parameters can be of a ZFS file system within system 100. In some examples, a first parameter can be altered to enable deeper pre-fetchs, forward reads and/or read aheads, etc. In some examples, a second parameter can be altered to enable pre-fetch data to be stored in a read cache (e.g., L2ARC/ZFS cache 112).

At block 210, during the generation of the synthetic backup, the ZFS file system (and associated processors) can read ahead (e.g., pre-fetch, forward read, etc.) data written between the first point in time t₁ when the full backup is generated and the second point in time t₂ when an incremental backup is generated.

At block 212, the pre-fetched data or other data obtained/retrieved from one or more forward read operations in block 210 can be stored at a read cache, e.g. L2ARC/ZFS cache 112.

At block 214, during the generation of the synthetic backup, the pre-fetched data stored at the read cache 112 can be supplied for the merge operation with the full backup generated at time t₁. In general, the read cache 112 stores data that is not yet required for the merge operation (e.g., pre-fetch data). When or if the data is later required for a merge operation, the data can be quickly read from the ‘fast’ read cache 112 because it was pre-fetched there, as opposed to a conventional solution which requires that the data be read from the substantially slower storage system 106. These pre-fetch operations can aid in preventing the generation of the synthetic backup from interfering with the normal operation of the storage system, as discussed above. Pre-fetching spreads out the requisite read operations for the synthetic backup over a larger period of time, or slots them in to periods of low I/O or demand on the cloud storage system 106, whereas the conventional approach concentrates the requisite read operations into a single point in time by requesting all of the read operations at the instant the synthetic backup generation is initiated.

At block 216, a determination can be made as to whether the merge operation (e.g., generation of synthetic backup) is completed or was successful. In some embodiments, this determination can be based on whether there are more forward reads (e.g., pre-fetched data, etc.) in cache 112 that are needed for a merge operation. When there are more forward reads, the method can return to block 214. When there are no more forward reads, the method can return to block 204, where another incremental backup can be generated (e.g., at another point in time subsequent to both t₁ and t₂).

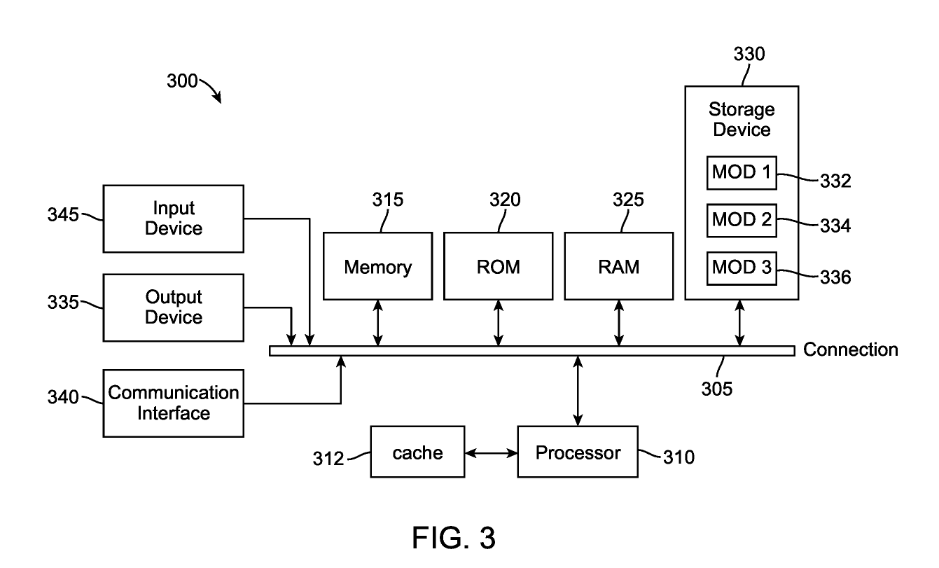

FIG. 3 depicts an example computing system 300 in which one or more aspects and embodiments of the present disclosure can be provided. The components of computing system 300 are illustrated as being communicatively coupled to one another via connection 305. Connection 305 can be a physical connection such as a bus, or a direct connection into processor 310, such as in a chipset or system-on-chip architecture. Connection 305 can also be a virtual connection, networked connection, or logical connection.

In some embodiments computing system 300 is a distributed system in which the functions described in this disclosure can be distributed within a datacenter, multiple datacenters, a peer network, throughout layers of a fog network, etc. In some embodiments, one or more of the described system components represents many such components each performing some or all of the function for which the component is described. In some embodiments, the components can be physical or virtual devices.

Example system 300 includes at least one processing unit (CPU or processor) 310 and connection 305 that couples various system components including system memory 315, read only memory (ROM) 320 or random access memory (RAM) 325 to processor 310. Computing system 300 can include a cache of high-speed memory 312 connected directly with, in close proximity to, or integrated as part of processor 310.

Processor 310 can include any general purpose processor and a hardware service or software service, such as services 332, 334, and 336 stored in storage device 330, configured to control processor 310 as well as a special-purpose processor where software instructions are incorporated into the actual processor design. Processor 310 may essentially be a completely self-contained computing system, containing multiple cores or processors, a bus, memory controller, cache, etc. A multi-core processor may be symmetric or asymmetric.

To enable user interaction, computing system 300 includes an input device 345, which can represent any number of input mechanisms, such as a microphone for speech, a touch-sensitive screen for gesture or graphical input, keyboard, mouse, motion input, speech, etc. Computing system 300 can also include output device 335, which can be one or more of a number of output mechanisms known to those of skill in the art. In some instances, multimodal systems can enable a user to provide multiple types of input/output to communicate with computing system 300. Computing system 300 can include communications interface 340, which can generally govern and manage the user input and system output, and also connect computing system 300 to other nodes in a network. There is no restriction on operating on any particular hardware arrangement and therefore the basic features here may easily be substituted for improved hardware or firmware arrangements as they are developed.

Storage device 330 can be a non-volatile memory device and can be a hard disk or other types of computer readable media which can store data that are accessible by a computer, such as magnetic cassettes, flash memory cards, solid state memory devices, digital versatile disks, cartridges, battery backed random access memories (RAMs), read only memory (ROM), and/or some combination of these devices.

The storage device 330 can include software services, servers, services, etc., that when the code that defines such software is executed by the processor 310, it causes the system to perform a function. In some embodiments, a hardware service that performs a particular function can include the software component stored in a computer-readable medium in connection with the necessary hardware components, such as processor 310, connection 305, output device 335, etc., to carry out the function.

Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, without departing from the scope of the disclosure.

1. A method comprising:
generating a full backup of a data source, where the full backup is generated at an initial timestamp;
generating a first incremental backup of the data source, where the first incremental backup is generated at a first timestamp subsequent to the initial timestamp, and wherein the first incremental backup comprises one or more modifications made between the initial timestamp and the first timestamp to data stored in the data source; and
generating, from at least the full backup and the first incremental backup, a first synthetic backup of the data source by:
altering one or more file system parameters of the data source;
based on the file system parameters, performing forward reads for the first incremental backup, wherein the forward reads correspond to data that was modified between the initial timestamp and the first timestamp;
in response to determining that forward read data has not been merged into a synthetic backup, storing the forward read data in a read cache; and
merging the full backup with the forward read data in the read cache.

2. The method of claim 1, further comprising generating a second incremental backup of the data source, where the second incremental backup is generated at a second timestamp subsequent to the first timestamp, and wherein the second incremental backup comprises one or more modifications made between the first timestamp and the second timestamp to data stored in the data source.

3. The method of claim 2, further comprising generating, from at least the full backup, the first incremental backup, and the second incremental backup, a second synthetic backup of the data source by performing forward reads for one or more of the first incremental backup and the second incremental backup and merging the full backup with the forward read data.

4. The method of claim 2, further comprising generating, from at least the first synthetic backup and the second incremental backup, a second synthetic backup of the data source by performing forward reads for the second incremental backup and merging the first synthetic backup with the forward read data.

5. The method of claim 1, wherein one or more of the full backup and the first incremental backup is a Veeam backup.

6. The method of claim 1, wherein one or more of the data source and the read cache implement EFS (Elastic File System).

7. The method of claim 6, wherein the read cache is a Level 2 Adjustable Replacement Cache (L2ARC) and the one or more file system parameters of the data source are L2ARC caching parameters.

8. The method of claim 1, wherein one or more of the data source and the read cache implement ZFS (Z File System) and the one or more file system parameters of the data source are ZFS prefetch parameters.

9. The method of claim 1, wherein merging the full backup with the forward read data in the read cache comprises performing a Veeam merge.

10. At least one non-transitory medium having stored therein instructions, which when executed by a processor, cause the processor to:
generate a full backup of a data source, where the full backup is generated at an initial timestamp;
generate a first incremental backup of the data source, where the first incremental backup is generated at a first timestamp subsequent to the initial timestamp, and wherein the first incremental backup comprises one or more modifications made between the initial timestamp and the first timestamp to data stored in the data source; and
generate, from at least the full backup and the first incremental backup, a first synthetic backup of the data source by:
altering one or more file system parameters of the data source;
based on the file system parameters, performing forward reads for the first incremental backup, wherein the forward reads correspond to data that was modified between the initial timestamp and the first timestamp;
in response to determining that forward read data has not been merged into a synthetic backup, storing the forward read data in a read cache; and
merging the full backup with the forward read data in the read cache.

11. The at least one non-transitory medium of claim 10, having further instructions which when executed by the processor cause the processor to:
generate a second incremental backup of the data source, where the second incremental backup is generated at a second timestamp subsequent to the first timestamp, and wherein the second incremental backup comprises one or more modifications made between the first timestamp and the second timestamp to data stored in the data source.

12. The at least one non-transitory medium of claim 11, having further instructions which when executed by the processor cause the processor to:
generate, from at least the full backup, the first incremental backup, and the second incremental backup, a second synthetic backup of the data source by performing forward reads for one or more of the first incremental backup and the second incremental backup and merging the full backup with the forward read data.

13. The at least one non-transitory medium of claim 11, having further instructions which when executed by the processor cause the processor to:
generate, from at least the first synthetic backup and the second incremental backup, a second synthetic backup of the data source by performing forward reads for the second incremental backup and merging the first synthetic backup with the forward read data.

14. The at least one non-transitory medium of claim 10, wherein one or more of the full backup and the first incremental backup is a Veeam backup.

15. The at least one non-transitory medium of claim 10, having further instructions which when executed by the processor cause the processor to:
implement EFS (Elastic File System) for one or more of the data source and the read cache.

16. The at least one non-transitory medium of claim 15, wherein the read cache is a Level 2 Adjustable Replacement Cache (L2ARC) and the one or more file system parameters of the data source are L2ARC caching parameters.

17. The at least one non-transitory medium of claim 10, wherein one or more of the data source and the read cache implement ZFS (Z File System) and the one or more file system parameters of the data source are ZFS prefetch parameters.

18. The at least one non-transitory medium of claim 10, having further instructions which when executed by the processor cause the processor to:
merge the full backup with the forward read data in the read cache by performing a Veeam merge.
